(19) United States
(12) Patent Application Publication
(10) Pub. No.: US 2015/0112754 A1
(43) Pub. Date: Apr. 23, 2015

(54) USER INTENT TRACKING STREAMS

(71) Applicants: Sandra Lynn Godsey, San Jose, CA (US); Steven Romero, Portland, OR (US); Jeremiah Jose Akin, Pleasant Hill, CA (US)

(72) Inventors: Sandra Lynn Godsey, San Jose, CA (US); Steven Romero, Portland, OR (US); Jeremiah Jose Akin, Pleasant Hill, CA (US)

(73) Assignee: EBAY INC., SAN JOSE, CA (US)

(21) Appl. No.: 14/056,762

(22) Filed: Oct. 17, 2013

(51) Int. Cl. G06Q 30/02

(52) U.S. Cl. CPC G06Q 30/0201
USPC 705/7.29

(57) ABSTRACT

Systems, methods and media are proposed for user intent tracking streams. One example embodiment relates to a system that comprises an identification module to identify a plurality of aspects of contextual or personal information relating to a user, and an analysis module to analyze the plurality of aspects of contextual or personal information to identify user intent or a likelihood relating to a pre-determined action. The system further comprises a correlation module to correlate the user intent or likelihood with at least a sub-set of the analyzed aspects of contextual or personal information to identify an intent tracking stream for the user, the intent tracking stream based on the correlated sub-set, and a tracking module to track the intent tracking stream as a user identifier or a predictor of the pre-determined action.

### TECHNICAL FIELD

This application relates generally to data processing within a network-based system operating over a distributed network, and more specifically to systems, methods and media to provide user intent tracking streams. In some examples, the tracking streams are based on aspects of consolidated contextual or personal data, allowing improved presentation of actionable or relevant information to users.

### BACKGROUND

The ubiquitous use of smart phones and other mobile devices with data connections and location determination capabilities is rapidly changing the way people interact, shop for products and services, and manage accounts. Smart phones, for example, can provide users with nearly instant information regarding a wide range of information, such as product availability, friend locations, or pricing. Smart phones also commonly include mechanisms, such as global positioning system (GPS) receivers, that allow the devices to constantly update location information.

Notification overload is increasingly common on modern mobile devices. The more notifications received that are not actionable or pertinent to a user, the more likely the user is to turn off notifications or uninstall an application altogether. Modern technology changes can lead to information overload. It is difficult to discern user intent, or present relevant information to users in all the noise.

### SUMMARY

The present inventors have recognized, among other things, that problems to be solved can include those discussed above. The present subject matter can help provide a solution to these problems, such as by presenting targeted information to users based on intent tracking streams. An intent tracking stream may be based on consolidated aspects of contextual or personal data. In some examples, a solution to information overload can include restricting notifications, such as eliminating messages when users cannot act on them, and increasing the likelihood of having users take action on notifications when they are delivered.

In an example embodiment, a system comprises an identification module to identify a plurality of aspects of contextual or personal information relating to a user; an analysis module to analyze the plurality of aspects of contextual or personal information to identify a user intent or a likelihood relating to a pre-determined action; a correlation module to correlate the user intent or likelihood with at least a sub-set of the analyzed aspects of contextual or personal information to identify an intent tracking stream for the user, the intent tracking stream based on the correlated sub-set; and a tracking module to track the intent tracking stream as a user identifier or a predictor of the pre-determined action, and wherein each of the modules executes on one or more computer processors.

In one embodiment, the tracking module may track the intent tracking stream in a marketplace environment and take an action based on the identified intent tracking stream.

The system may further comprise a targeting module to present real-time targeted information, relevant to the pre-determined action, to the user based on the identified intent tracking stream.

The example system may still further comprise an aggregation module to identify the intent tracking stream based on aspects of contextual or personal information identified across a multiplicity of devices, sessions, interfaces or communication channels. The aggregation module may further aggregate the plurality of aspects of contextual or personal information across a multiplicity of users to identify an intent tracking stream as a collective user identifier or a predictor of the pre-determined action.

In another example embodiment, a machine readable medium includes instructions, which when performed by a machine, causes the machine to perform the operations of identifying a plurality of aspects of contextual or personal information relating to a user; analyzing the plurality of aspects of contextual or personal information to identify a user intent or a likelihood relating to a pre-determined action; correlating the user intent or likelihood with at least a sub-set of the analyzed aspects of contextual or personal information to identify an intent tracking stream for the user, the intent tracking stream based on the correlated sub-set; and tracking the intent tracking stream as a user identifier or a predictor of the pre-determined action.

These and other examples and features of the present disclosure will be set forth in part in the following Detailed Description. This Summary is intended to provide non-limiting examples of the present disclosure. It is not intended to provide an exclusive or exhaustive explanation. The Detailed Description below is included to provide further information about the present disclosure.

### BRIEF DESCRIPTION OF THE DRAWINGS

Some embodiments are illustrated by way of example and not limitation in the figures of the accompanying drawings in which:

FIG. 1 is a block diagram depicting a system for intent tracking, according to an example embodiment.

FIG. 2 is a block diagram illustrating an environment for implementing intent tracking methods, according to an example embodiment.

FIG. 3 is a block diagram illustrating a mobile device, according to an example embodiment.

FIG. 4 is a block diagram illustrating a network-based system for implementing intent tracking systems and delivering intent tracking services, according to example embodiments.

FIG. 5 is a block diagram illustrating modules of an intent tracking machine, according to an example embodiment.

FIG. 6 is a flowchart illustrating a method for intent tracking, according to an example embodiment.

FIG. 7 is a diagrammatic representation of a machine, in the example form of a computer system, within which a set of instructions for causing the machine to perform any one or more of the methodologies discussed herein may be executed.

### DEFINITIONS

Geolocation—For the purposes of this specification and the associated claims, the term “geolocation” is used to refer to a geographic location, such as a longitude/latitude combination or a street address, or a region defined by a ZIP code, for example. The term “geolocation” or location is also used within this specification and claims in reference to a physical location, for example, associated with a retail outlet (e.g., store), a movie theater location, or a dining house. The term includes detecting a user's presence or location. It may involve active sensing (for example, with an accelerometer or other sensor) or a passive identification (for example, with RFID). Location identification can be used as a trigger to present targeted information or other content in an interface.

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Contextual information—For the purposes of this specification and the associated claims, the term “contextual information” is used to refer to aspects of environmental data, such as time and weather conditions, among others. The contextual information generally refers to conditions describing an individual's (e.g., user, member of population etc.) environment and/or activities. For example, one aspect of contextual information can include a user's direction of movement. Another aspect can include current activity (e.g., working, driving, playing golf, shopping, attending a pop concert, lining up for show tickets etc.), current weather conditions, time of day, and time of year (e.g., season), among other things. In certain examples, contextual information about a user can also include aspects such as past events, purchase history, or other historical data about the user. In other examples, contextual information can include demographic information about an individual (e.g. income level, gender, ethnicity, and so forth). In some examples, contextual data can include a user's physical, facial or eye movements, or other biometric data. Contextual information may also include a user's exit behavior when leaving a website, for example. Contextual information may have situational relevance, such as a local change in the weather, a racecar driver's death, or relate to other newsworthy or interesting aspects of information.

Personal information—For the purposes of this specification and the associated claims, the term “personal information” may include, but is not limited, to aspects such as age, gender, schooling, financial information, “likes,” interests, owned items, wants/needs, online behavior, and so forth. Personal information may also include user profile or engagement profile information. It will be appreciated that many other aspects of personal information are possible.

Device—For the purposes of this specification and the associated claims, the term “device” or “mobile device” includes a device, a vehicle, structure or a conveyance carrying or operating a portable electronic device in communication with a network-based system.

Interface—For the purposes of this specification and the associated claims, the term “interface” includes any interface that can convey information to a user or receive information from a user. An interface may be associated with a mobile device, or it may not. An interface can exist in many forms. For example, the interface may interact with a user, in a functional or physical way, and may contribute and/or consume content. The interface may or may not be associated with a device. The interface may be mouse driven, voice driven, or touch driven, for example. An associated device may or may not be network enabled. The device or interface may be associated with local or proximate processing capability. In some examples, a physical interface may be presented by “smart” glasses (for example, Google glasses). In other embodiments, an interface may be intangible, such as a hologram. In further examples, the interface may be a non-mobile surface, such as a wall, a table-top, or a side of an appliance. In other examples, an interface may be provided in a kiosk, or by a surface or device inside a motor vehicle, for example.

Targeted information—For the purposes of this specification and the associated claims, the term “targeted information” includes consumable information or non-consumable information (for example, metadata). Consumable examples can be displayed, emailed, pushed, or included in a text message. The information may include tiles, social media, digital data, physical (billboard) embodiments, audio files, commercial art, smart advertisements and so forth. In some examples, targeted information may include “ad content.” The information may be targeted in that it is presented during a specific window of the day, or at a specific moment or opportunity identified as being inspirational to a user. An inspirational moment could be as short as forty five seconds, for example.

Ad content—For the purposes of this specification and the associated claims, the term “ad content” includes promotional information. A promotion in ad content need not be tied to commerce, or payment, or a transaction, but will usually be associated with receipt of some kind of value. The value could relate to a good or a service (or hybrid of same).

Session—For the purposes of this specification and the associated claims, the term “session” includes the idea that a user has the intent to achieve a particular task, with that task potentially being spread over multiple devices and extended time periods. The user could pick up a session on a different device, or after a lapse of time, and so forth. A user could have many parallel sessions going on simultaneously, for example. A session may include user phases, such as a discovery phase, an exploratory phase, a follow-up phase, and so forth. Sessions may be assessed or tied to a success metric, such as a “Bid-Buy-Offer-Watch-Ask seller question” (BBOWA) metric, for example.

The definitions and examples discussed above merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. However, it will be evident to one skilled in the art that the present subject matter may be practiced without these specific details.

### DETAILED DESCRIPTION

There is a device ubiquity in the network-enabled world of today. Devices such as smart phones, tablets, laptop computers, “smart” motor vehicles, home appliances and the like are used almost constantly to receive or exchange information. Devices can, passively or actively, sense our presence. Commercial entities or content providers are increasingly looking to give users more fruitful engagement opportunities online or in the “real world”, such as “near store” or “in-store” experiences. Meaningful engagement opportunities may be based on aspects of contextual data such as time of day, spending budgets, and so forth. These aspects may be identified based on preferences or aspects of personal information. In this environment, it can be very difficult to penetrate through the noise and reach users in a meaningful way.

Viewed broadly, one aspect of the present subject matter relates to the creation and use of intent tracking streams. An intent tracking stream may, in one way, be considered somewhat analogous to the vapor trail of a jet. In our case, the jet is a user, and the vapor trial is an intent tracking stream that relates to that user. The stream left by or used by the user identifies the user, and in some examples, can predict a user's actions. The intent tracking stream may be based on aspects of contextual or personal information, or on aggregations or consolidations of such data. The intent tracking stream may include an opaque data string of the type described in the cross-referenced patent application mentioned above. In another aspect of the disclosed subject matter, a user's intent (i.e. intended behavior or likely next action) is tracked across multiple devices and across one or more sessions or communication channels. Targeted information may be presented to the tracked user based on the user's tracked intent.

In some examples, an intent tracking stream may be used to predict user behavior. In some examples, this prediction may be based on past user behavior. In some instances, an intent tracking stream may be used as a predictor of a pre-determined user action, such as purchasing a product. Other actions are possible in a user session, such as user action phases, which include a discovery phase, an exploratory phase, a follow-up phase, and so forth.

High conversion rates are possible when there is an urgency or immediacy associated with the presentation of real-time targeted information. One has to catch a user before he or she leaves the online or real world marketplace environment. Analysis of user's exit behavior in the online or real world can be used, for example, as an aspect of contextual information to predict when a user (for example, identified by an intent tracking stream) may leave a session.

A user's intent tracking stream may be based on information derived from user activity or sessions occurring across a multiplicity of devices, or communication channels. In this way, relevant and richer data may be exchanged to the benefit of both the user and recipient. Merchants and online content providers, for example, can focus on selected clients or consumer segments without having to resort to batch emailing techniques, data dumps, or analyzing sparse or imprecise click-through rates. Frustration and screen clutter generated by unsolicited notifications or advertisements can be minimized. In appropriate applications, brand equity or awareness can be enhanced while meeting the requirements of consumer privacy laws. In summary, the present disclosure seeks to employ a consolidation of data, at the confluence of the real and on-line worlds, to inspire users and present real-time targeted information.

### Example System

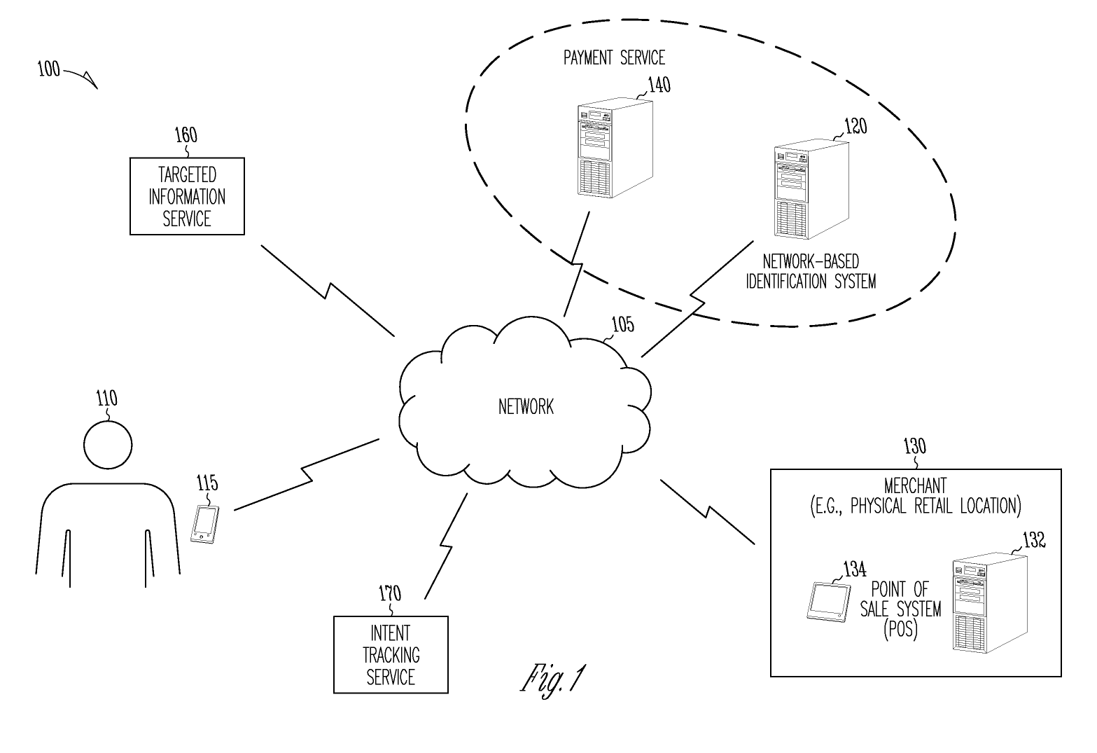

FIG. 1 is a block diagram depicting a system in which an intent tracking stream may be identified or used, according to an example embodiment. The system 100 can include a user 110, a network-based identification system 120, a merchant (online or physical retail) 130, a network-based payment service 140, a targeted information service 160, and an intent tracking service 170. In an example, the user 110 can connect or is connected to the network-based identification system 120, the targeted information service 160, or the intent tracking service 170 via a mobile device 115 (e.g., a smart phone, PDA, laptop, or a similar mobile electronic device capable of some form of data connectivity). In an example, the merchant 130 can operate computer systems, such as an inventory system 132 or a point of sale (POS) system 134, among others. The network-based identification system 120 can interact with any of the systems used by the merchant 130 for operation of the merchant's retail or service business. In an example, the network-based identification system 120 can work with both the POS system 134 and inventory system 132 to obtain access to inventory available at individual retail locations run by the merchant 130 and match merchandise on which the merchant 130 wants to offer deals via the network-based identification system 120. Additionally, the network-based payment service 140 can also interact with the merchant 130 via the POS system 134, enabling the merchant 130 to provide payment services offered by the network-based payment service 140. The merchant 130 can also interact with a targeted information service 160.

In accordance with one aspect of the present disclosure, any one or more of the merchant 130, the intent tracking service 170, the targeted information service 160, the network-based payment service 140, or the network-based identification system 120 can identify a plurality of aspects of contextual or personal information relating to the user 110. In some examples, these aspects are analyzed to identify one or more intended actions of a user 110 (user intent), or in some examples a likelihood of an action being taken by the user 110. The action may be pre-determined and watched for as a trigger to something else. The user intent or likelihood is correlated, in one example, with at least a sub-set of the analyzed aspects of contextual or personal information to identify an intent tracking stream associated with the user 110. The intent tracking stream may be based on the correlated sub-set. Any one or more of the abovementioned entities can track the intent tracking stream as a user identifier or a predictor of the pre-determined action. In another aspect of the disclosed subject matter, a user's intent (i.e. intended behavior or likely next action) is tracked across multiple devices and across one or more sessions or communication channels. Targeted information may be presented to the tracked user 110 based on the user's tracked intent.

### Example Operating Environment

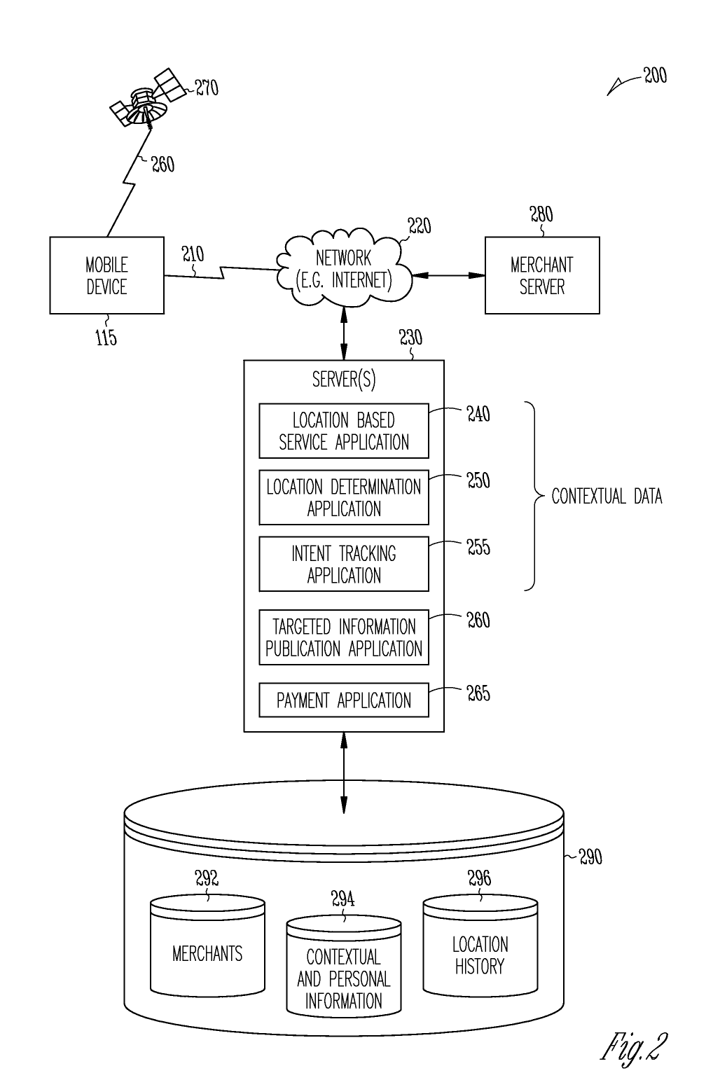

FIG. 2 is a block diagram illustrating an environment for operating a mobile device 115, according to an example embodiment. The environment 200 is an example environment within which methods of intent tracking can occur. The environment 200 can include a mobile device (or merely an interface, as defined above) 115, a communication connection 210, a network 220, servers 230, a communication satellite 270, a merchant server 280, and a database 290. The servers 230 can optionally include a location based service application 240, a location determination application 250, an intent tracking application 255, a targeted information publication application 260, and a payment application 265. The database 290 can optionally include merchant databases 292, contextual and personal information databases 294, and/or location history databases 296. Other databases are possible, such as a user-controlled data repository of the type described in the cross-referenced patent application mentioned further above.

As used herein, a “database” is a data storage resource and may store data structured as a text file, a table, a spreadsheet, a relational database (e.g., an object-relational database), a triple store, a hierarchical data store, or any suitable combination thereof. The network 105 or 220 may be any network that enables communication between or among machines, databases, and devices. Accordingly, the network 105 or 220 may be a wired network, a wireless network (e.g., a mobile or cellular network), or any suitable combination thereof. The network 105 or 220 may include one or more portions that constitute a private network, a public network (e.g., the Internet), or any suitable combination thereof.

The mobile device 115 represents one example device that can be utilized by a user 110 to receive offers and process payments in response to the presentation to the user 110 of targeted information based on the user's intent tracking stream. The mobile device 115 may be any one of a variety of device types (for example, a cellular telephone, a personal digital assistant (PDA), a Personal Navigation Device (PND), a handheld computer, a tablet computer, a notebook computer, or other type of movable device). The mobile device 115 may interface via a communication connection 210 with a network 220. Depending on the form of the mobile device 115, any one of a variety of communication connection types 210 and networks 220 may be used.

For example, the communication connection 210 may be a Code Division Multiple Access (CDMA) connection, a Global System for Mobile communications (GSM) connection, or other type of cellular connection. Such communication connections 210 may implement any one of a variety of data transfer technologies, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the network 220 may include a cellular network that has a plurality of cell sites of overlapping geographic coverage interconnected by cellular telephone exchanges. These cellular telephone exchanges may be coupled to a network backbone (for example, the public switched telephone network (PSTN), a packet-switched data network, or to other types of networks).

In another example, the communication connection 210 may be a Wireless Fidelity (Wi-Fi, IEEE 802.11x type) connection, a Worldwide Interoperability for Microwave Access (Wi-MAX) connection, or another type of wireless data connection. In such an embodiment, the network 220 may include one or more wireless access points coupled to a local area network (LAN), a wide area network (WAN), the Internet, or other packet-switched data network.

In yet another example, the communication connection 210 may be a wired connection, for example an Ethernet link, and the communication network 220 may be a LAN, a WAN, the Internet, or other packet-switched data network. Accordingly, a variety of different configurations are expressly contemplated.

A plurality of servers 230 may be coupled via interfaces to the network 220, for example, via wired or wireless interfaces. The interfaces may be provided on mobile devices 115 or POS system 134. The servers 230 may be configured to provide various types of services to the mobile device 115. For example, one or more servers 230 may execute location based service (LBS) applications 240, which interoperate with software executing on the mobile device 115 to provide LBSs 240 to a user 110. LBSs 240 can use knowledge of the mobile device's location, and/or the location of other devices, to provide location-specific information, recommendations, notifications, interactive capabilities, and/or other functionality to a user 110. For example, an LBS application 240 can provide location data to a network-based identification system 120, which can then be used to assist in generating offers relevant to the user's current location and enable payment via the network-based payment service 140. Knowledge of the mobile device's location, and/or the location of other devices, may be obtained through interoperation of the mobile device 115 with a location determination application 250 executing on one or more of the servers 230. Location information may also be provided by the mobile device 115 without use of a location determination application 250. In certain examples, the mobile device 115 may have some limited location determination capabilities that are augmented by the location determination application 250. In some examples, the servers 230 can also include publication application 260 for providing location-aware offers that may be triggered by present or past identifications with the network-based identification service 120. In certain examples, location data can be provided to the targeted information publication application 260 by the location determination application 250. In some examples, the location data provided by the location determination application 250 can include merchant information (e.g., identification of a retail location). In certain examples, the location determination application 250 can receive signals via the network 220 to further identify a location. For example, a merchant 130 may broadcast a specific IEEE 802.11 service set identifier (SSID) that can be interpreted by the location determination application 250 to identify a particular retail location. In another example, the merchant 130 may broadcast an identification signal via radio-frequency identification (RFID), near-field communication (NFC), or a similar protocol that can be used by the location determination application 250.

### Example Mobile Device

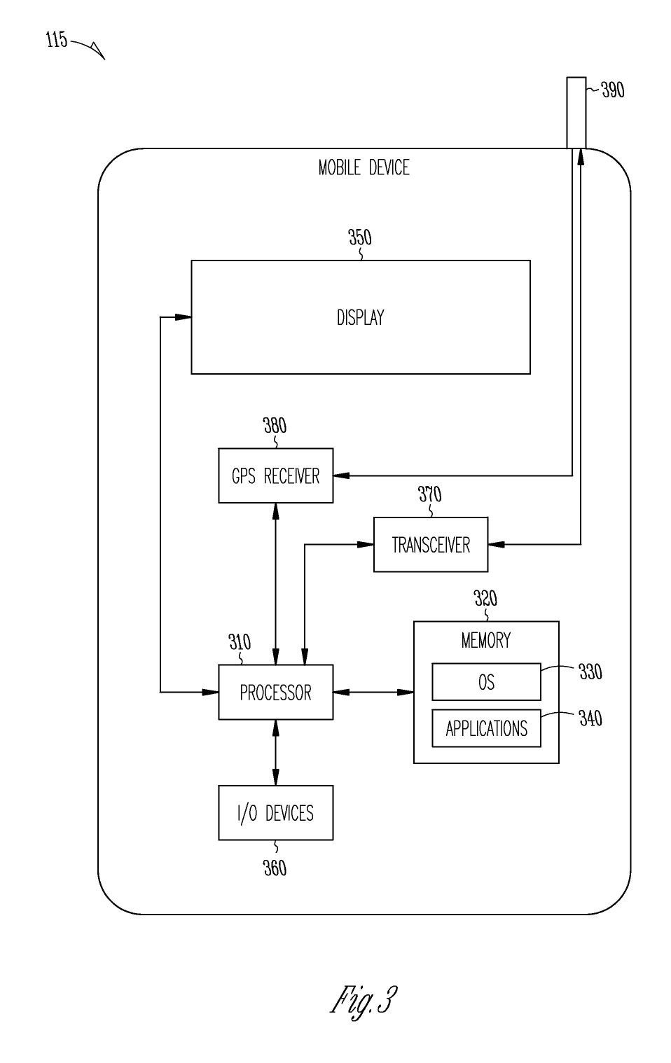

FIG. 3 is a block diagram illustrating a mobile device 115, according to an example embodiment. The mobile device 115 may include a processor 310. The processor 310 may be any one of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor 310. The memory 320 may be adapted to store an operating system (OS) 330, as well as application programs 340, such as a mobile location enabled application that may provide LBSs 240 to a user 110. The processor 310 may be coupled, either directly or via appropriate intermediary hardware, to a display 350 (or interface, as defined above) and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the communication connection 210 with the network 220 may be established. Further, in some configurations, a GPS receiver 380 may also make use of the antenna 390 to receive GPS signals.

### Example Platform Architecture

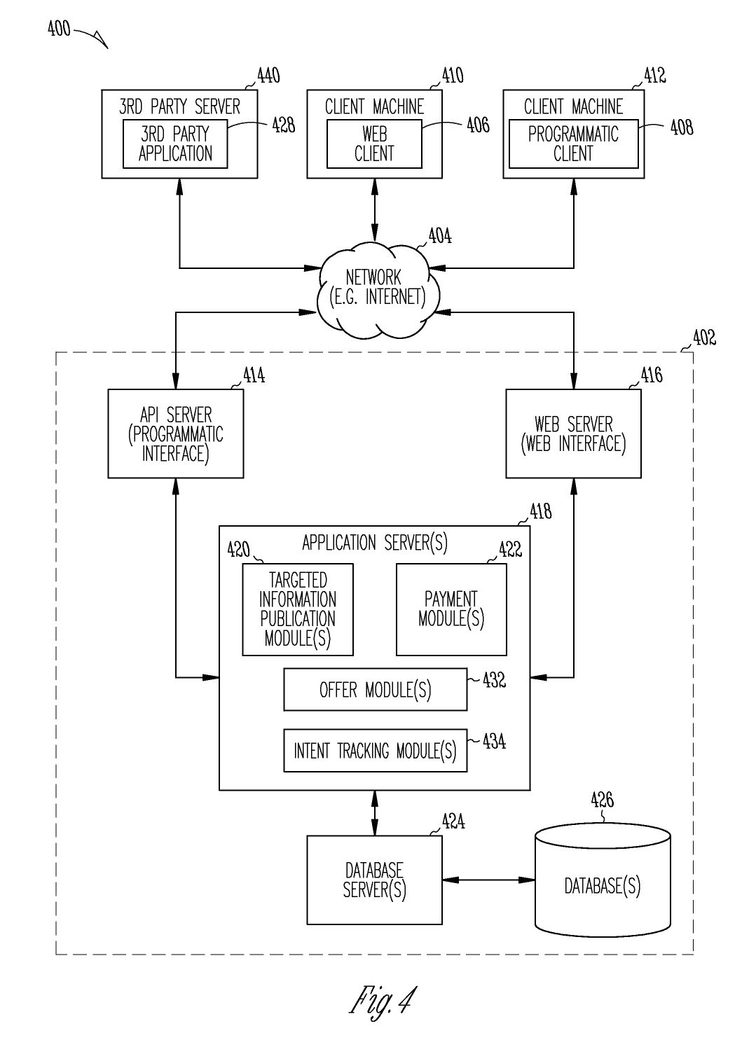

FIG. 4 is a block diagram illustrating a network-based system 400 for implementing intent tracking streams and methods, according to example embodiments. The block diagram depicts a network-based system 400 (in the exemplary form of a client-server system), within which an example embodiment can be deployed. A networked system 402, in the example form of a network-based identification and payment system, provides server-side functionality via a network 404 (e.g., the Internet or WAN) to one or more client machines 410, 412. FIG. 4 illustrates, for example, a web client 406 (e.g., a browser, such as the Internet Explorer browser developed by Microsoft Corporation of Redmond, Wash. State) and a programmatic client 408 (e.g., WHERE™ smartphone application from Where, Inc. of Boston, Mass. or FOURSQUARE™ smartphone application from Foursquare, Inc. of New York, N.Y.) executing on respective client machines 410 and 412. In an example, the client machines 410 and 412 can be in the form of a mobile device, such as the mobile device 115 of FIG. 1.

An Application Programming Interface (API) server 414 and a web server 416 are coupled to, and provide programmatic and web interfaces respectively to, one or more application servers 418. The application servers 418 host one or more targeted information publication modules 420 (in certain examples, these can also include commerce modules, advertising modules, and marketplace modules, to name a few), intent tracking modules 434, payment modules 422, and location-aware offer modules 432. The application servers 418 are, in turn, shown to be coupled to one or more database servers 424 that facilitate access to one or more databases 426. In some examples, the application server 418 can access the databases 426 directly and without the need for a database server 424.

The targeted information publication modules 420 may provide a number of publication functions and services to users 110 that access the networked system 402. The intent tracking modules 434 may provide a number of tracking functions and services to users 110 that access the networked system 402. The payment modules 422 may, likewise, provide a number of payment services and functions to users 110. The payment modules 422 may allow users 110 to accumulate value (e.g., in a commercial currency, such as the U.S. dollar, or a proprietary currency, such as “points”) in accounts, and then to later redeem the accumulated value for products (e.g., goods or services) that are advertised or made available via the various targeted information publication modules 420 within retail locations, or within external online retail venues. The payment modules 422 may also be configured to present or facilitate redemption of offers, generated by the location-aware offer modules 432, to a user 110 during checkout (or prior to checkout, while the user is still actively shopping). The payment modules 422 can also be configured to enable identification based payment processing. The location-aware offer modules 432 may provide real-time location-aware offers (e.g., coupons or immediate discount deals on targeted products or services) to users 110 of the networked system 402. The location-aware offer modules 432 can be configured to use all of the various communication mechanisms provided by the networked system 402 to present offer options to users 110. The offer options can be personalized based on current location, time of day, user profile data, past purchase history, or recent physical or online behaviors recorded by the network-based system 400, among other things. While the targeted information publication modules 420, payment modules 422, and location-aware offer modules 432 are shown in FIG. 4 to form part of the networked system 402, it will be appreciated that, in alternative embodiments, the payment modules 422 may form part of a payment service that is separate and distinct from the networked system 402, such as the network-based payment service 140 of FIG. 1. Additionally, in some examples, the location-aware offer modules 432 may be part of the payment service or may form an offer generation service separate and distinct from the networked system 402. In certain examples, the network-based identification system 120 of FIG. 1 can include some or all of the application severs 418.

Further, while the network-based system 400 shown in FIG. 4 employs client-server architecture, the present invention is of course not limited to such an architecture, and could equally well find application in a distributed, or peer-to-peer architecture system, for example. The various targeted information publication modules 420, payment modules 422, and location-aware offer modules 432 could also be implemented as standalone systems or software programs, which may not have networking capabilities.

The web client 406 accesses the various targeted information publication modules 420, payment modules 422, and location-aware offer modules 432 via the web interface supported by the web server 416. Similarly, the programmatic client 408 accesses the various services and functions provided by the targeted information publication modules 420, payment modules 422, and location-aware offer modules 432 via the programmatic interface provided by the API server 414. The programmatic client 408 may, for example, be a smartphone application (e.g., the PAYPAL™ payment application developed by eBay, Inc., of San Jose, Calif.) to enable users 110 to make a series of payments directly from their smartphones.

FIG. 4 also illustrates a third party application 428, executing on a third party server machine 440, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide merchants 130 with access to the offer modules 432 for configuration purposes. In certain examples, merchants 130 can use programmatic interfaces provided by the API server 414 to develop and implement rules-based pricing schemes that can be implemented via the targeted information publication modules 420, payment modules 422, and location-aware offer modules 432.

### Example Modules

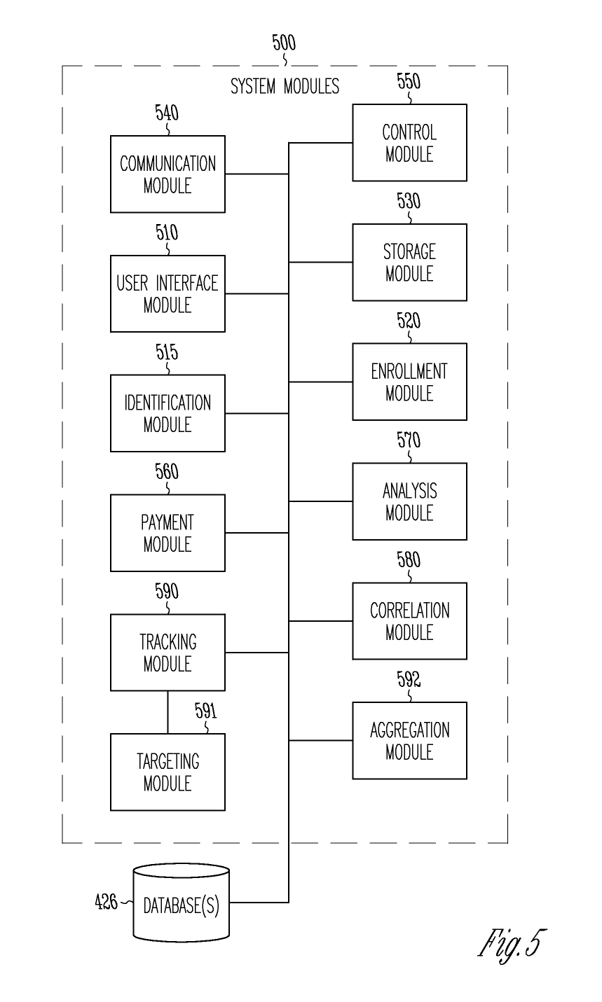

FIG. 5 is a block diagram illustrating components of an intent tracking machine 500 for implementing particular disclosed embodiments. The intent tracking machine 500 may be associated with the intent tracking service 170 in FIG. 1, or otherwise form part of the network 105 (FIG. 1), 220 (FIG. 2) or 404 (FIG. 4).

The intent tracking machine 500 is shown as including a user interface module 510, an identification module 515, an enrollment module 520, a storage module 530, a communication module 540, a control module 550, a payment module 560, an analysis module 570, a correlation module 580, a tracking module 590, a targeting module 591, and an aggregation module 592, all configured to communicate with each other (e.g., via a bus, shared memory, or a switch).

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The user interface module 510 may be configured to provide a user interface to a user 110 connecting to the intent tracking machine 500. The intent tracking machine 500 may serve a web page or mobile application. The user 110 may respond to the user interface by enrolling, or logging in (or other authentication), e.g., with a user name and password. The login information provided by the user 110 may be stored by the storage module 530 and used by the identification module 515 to identify the user 110. The storage module 530 may also be operated by a database controller to store user-controlled personal or contextual data in one or more of the databases 426 (FIG. 4 and FIG. 5). The enrollment module 520 is configured to enroll users 110 with the services of the intent tracking machine 500. The communication module 540 is configured to receive an enrolled user authentication (log in) and personal or contextual data relating to the user (110 in FIG. 1). The control module 550 is configured to allow an authenticated user (110 in FIG. 1) to supplement or modify the received personal or contextual data and to select recipients of user-identified aspects of the received personal data. A recipient may be a targeted information service 160 in FIG. 1, for example. The communication module 540 is further configured to communicate data to a selected recipient. The payment module 560 is configured to receive payment, or send payment to any party (e.g. user, device or service) connected to the network (105 in FIG. 1, 220 in FIG. 2, or 404 in FIG. 4).

The identification module 515 is further configured to identify a plurality of aspects of contextual or personal information relating to a user 110. This information may be collected by the applications, devices, machines, and/or interfaces discussed in this specification. The analysis module 570 is configured to analyze the plurality of aspects of contextual or personal information to identify a user intent (110 in FIG. 1) or a likelihood relating to a pre-determined action or event, taken either by the user (110 in FIG. 1) or by a third party. The correlation module 580 is configured to correlate the user intent or likelihood with at least a sub-set of the analyzed aspects of contextual or personal information to identify an intent tracking stream for the user 110, the intent tracking stream based on the correlated sub-set. The tracking module 590 is configured to track the intent tracking stream as a user identifier or a predictor of the pre-determined action or event. The tracking module 590 may be further configured to track the intent tracking stream in a marketplace environment and take an action based on the identified intent tracking stream. The targeting module 591 is configured to present real-time targeted information, relevant to the pre-determined action, to the user (110 in FIG. 1) or a targeted information service (160 in FIG. 1) based on the identified intent tracking stream. The aggregation module 592 is configured to identify the intent tracking stream based on aspects of contextual or personal information identified across a multiplicity of devices, sessions, interfaces or communication channels. The aggregation module 592 may be further configured to aggregate the plurality of aspects of contextual or personal information across a multiplicity of users 110 to identify an intent tracking stream as a collective user identifier or a predictor of the pre-determined action or event.

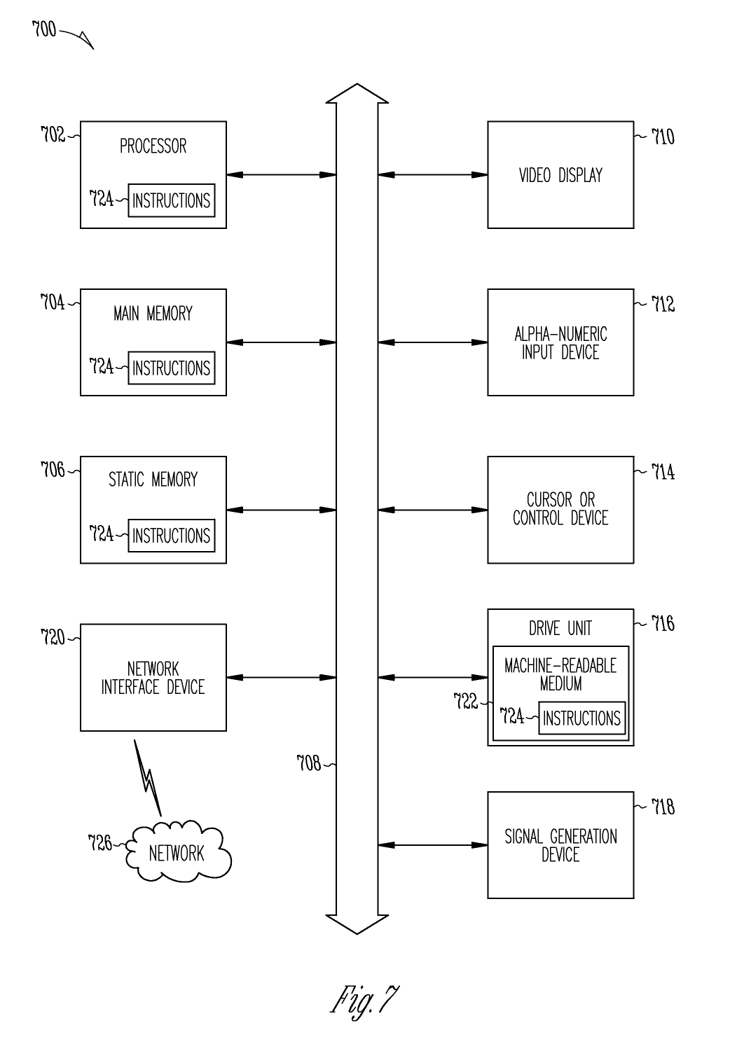

Any of the machines, databases, or devices shown in the accompanying figures may be implemented in a general-purpose computer, which is modified (e.g., configured or programmed) by software to be a special-purpose computer to perform the functions described herein for that machine, database, or device. For example, a computer system able to implement any one or more of the methodologies described herein is discussed below with respect to FIG. 7.

### Example Methods

Any of the machines, databases, or devices described above may be used or configured, partially or entirely, as appropriate to perform one or more of the methods, operations, or functions described herein, or as set forth below in the following method steps. Other devices or systems may be employed. Some examples of the present disclosure include methods for use in user-controlled identity systems.

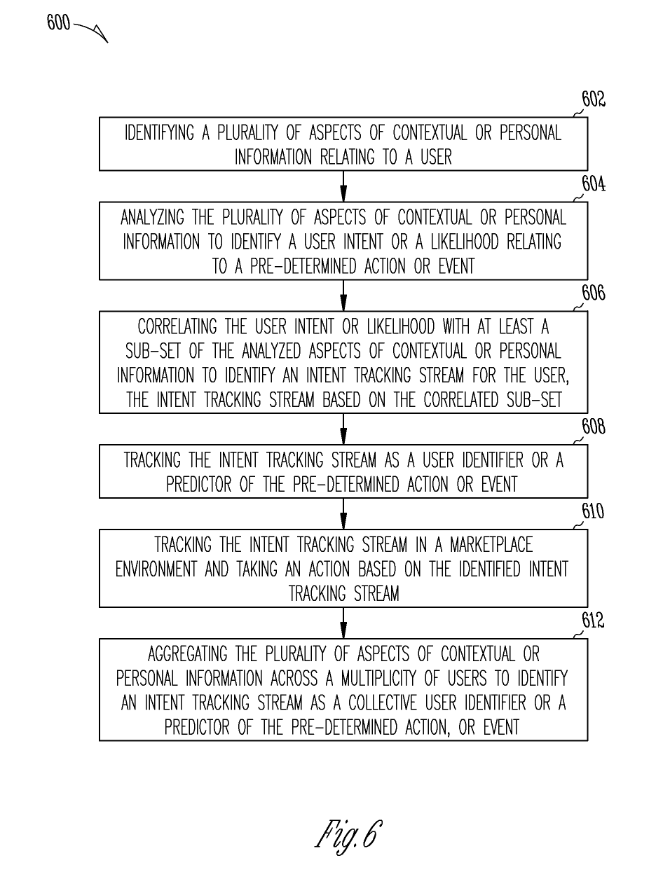

One such method is illustrated in FIG. 6. In this example embodiment, a method 600 includes: at block 602 identifying a plurality of aspects of contextual or personal information relating to a user 110; at block 604, analyzing the plurality of aspects of contextual or personal information to identify a user intent or a likelihood relating to a pre-determined action or event; at block 606, correlating the user intent or likelihood with at least a sub-set of the analyzed aspects of contextual or personal information to identify an intent tracking stream for the user 110, the intent tracking stream based on the correlated sub-set; and, at block 608, tracking the intent tracking stream as a user identifier or a predictor of the pre-determined action or event.

The method 600 may further comprise, at block 610, tracking the intent tracking stream in a marketplace environment and taking an action based on the identified intent tracking stream. The action taken may include presenting real-time targeted information, relevant to the pre-determined action, to the user 110. The intent tracking stream is based on aspects of contextual or personal information identified across a multiplicity of devices, sessions, interfaces or communication channels. Still further, method 600 may include, at block 612, aggregating the plurality of aspects of contextual or personal information across a multiplicity of users 110 to identify an intent tracking stream as a collective user identifier or a predictor of the pre-determined action, or event.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may, accordingly, configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmissions (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. For example, embodiments may be implemented using a computer program product; a computer program tangibly embodied in an information carrier; in a machine-readable medium for execution by, or to control the operation of, data processing apparatus; a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below, are set out hardware (e.g., machine) and software architectures that may be deployed, in various example embodiments.

### Example Machine Architecture and Machine-Readable Medium

FIG. 7 is a block diagram of a machine in the example form of a computer system 700 within which instructions 724, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that, individually or jointly, execute a set (or multiple sets) of instructions 724 to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

### Machine-Readable Medium

The drive unit 716 includes a machine-readable medium 722 on which is stored one or more sets of instructions 724 and data structures (e.g., software) embodying or used by any one or more of the methodologies or functions described herein. The instructions 724 may also reside, completely or at least partially, within the main memory 704, static memory 706, and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions 724 for execution by the machine and that cause the machine to perform any one or more of the methodologies of the present invention, or that is capable of storing, encoding or carrying data structures used by or associated with such instructions 724. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks 726 include a LAN, a WAN, the Internet, mobile telephone networks, Plain Old Telephone (POTS) networks, and wireless data networks (e.g., Wi-Fi and Wi-Max networks). The term “transmission medium” shall be taken to include any intangible medium that is capable of storing, encoding or carrying instructions 724 for execution by the machine, and includes digital or analog communications signals or other intangible media to facilitate communication of such software.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is, in fact, disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements, in addition to those listed after such a term in a claim, are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An intent tracking system comprising:
an identification module to identify a plurality of aspects of contextual or personal information relating to a user;
an analysis module to analyze the plurality of aspects of contextual or personal information to identify a user intent or a likelihood relating to a pre-determined action or event;
a correlation module to correlate the user intent or likelihood with at least a sub-set of the analyzed aspects of contextual or personal information to identify an intent tracking stream for the user, the intent tracking stream based on the correlated sub-set; and
a tracking module to track the intent tracking stream as a user identifier or a predictor of the pre-determined action or event, and wherein each of the modules executes on one or more computer processors.

2. The system of claim 1, wherein the tracking module is further to track the intent tracking stream in a marketplace environment and take an action based on the identified intent tracking stream.

3. The system of claim 2, further comprising a targeting module to present real-time targeted information, relevant to a pre-determined action, to a user based on the identified intent tracking stream.

4. The system of claim 1, further comprising an aggregation module to identify the intent tracking stream based on aspects of contextual or personal information identified across a multiplicity of devices, sessions, interfaces or communication channels.

5. The system of claim 4, wherein the aggregation module is further to aggregate a plurality of aspects of contextual or personal information across a multiplicity of users to identify an intent tracking stream as a collective user identifier or a predictor of the pre-determined action, or event.

6. A method comprising:
identifying a plurality of aspects of contextual or personal information relating to a user;
analyzing the plurality of aspects of contextual or personal information to identify a user intent or a likelihood relating to a pre-determined action or event;
correlating the user intent or likelihood with at least a sub-set of the analyzed aspects of contextual or personal information to identify an intent tracking stream for the user, the intent tracking stream based on the correlated sub-set; and
tracking the intent tracking stream as a user identifier or a predictor of the pre-determined action or event.

7. The method of claim 6, further comprising tracking the intent tracking stream in a marketplace environment and taking an action based on the identified intent tracking stream.

8. The method of claim 7, wherein the action taken includes presenting real-time targeted information, relevant to a pre-determined action, to a user.

9. The method of claim 6, wherein the intent tracking stream is based on aspects of contextual or personal information identified across a multiplicity of devices, sessions, interfaces or communication channels.

10. The method of claim 6, further comprising aggregating the plurality of aspects of contextual or personal information across a multiplicity of users to identify an intent tracking stream as a collective user identifier or a predictor of the pre-determined action or event.

11. A machine readable medium, including instructions, which when performed by a machine, causes the machine to perform the operations of:
identifying a plurality of aspects of contextual or personal information relating to a user;
analyzing the plurality of aspects of contextual or personal information to identify a user intent or a likelihood relating to a pre-determined action or event;
correlating the user intent or likelihood with at least a sub-set of the analyzed aspects of contextual or personal information to identify an intent tracking stream for the user, the intent tracking stream based on the correlated sub-set; and
tracking the intent tracking stream as a user identifier or a predictor of the pre-determined action or event.

12. The machine readable medium of claim 11, wherein the operations further comprise tracking the intent tracking stream in a marketplace environment and taking an action based on the identified intent tracking stream.

13. The machine readable medium of claim 12, wherein the action taken includes presenting or restricting real-time targeted information, relevant to a pre-determined action, to a user.

14. The machine readable medium of claim 11, wherein the intent tracking stream is based on aspects of contextual or personal information identified across a multiplicity of devices, sessions, interfaces or communication channels.

15. The medium of claim 11, wherein the operations further comprise aggregating the plurality of aspects of contextual or personal information across a multiplicity of users to identify an intent tracking stream as a collective user identifier or a predictor of the pre-determined action or event.
